(19) United States
(12) Patent Application Publication
(10) Pub. No.: US 2026/0167459 A1
(43) Pub. Date: Jun. 18, 2026

(54) ELEVATOR CAR CEILING ACCESS SYSTEM

(71) Applicant: Otis Elevator Company, Farmington, CT (US)

(72) Inventors: Vinothkumar R, Banglalore (IN); Vivek T, Banglaore (IN); Venkatesh R, Banglaore (IN); Bruno Joseph, Gien (FR); Arnaud Caze, Chailly en Gatinais (FR); Patrice DeGardin, Chatillon Sur Loire (FR); Jean-Baptiste Dubreuil, Isdes (FR); Gilles Bruno, Chateauneuf sur Loire (FR)

(21) Appl. No.: 19/419,366

(22) Filed: Dec. 15, 2025

(30) Foreign Application Priority Data
Dec. 17, 2024 (IN) 202411099940

(51) Int. Cl. B66B 11/02; E06C 1/18; E06C 1/393; E06C 7/02

(52) U.S. Cl. CPC B66B 11/0246; E06C 1/18; E06C 1/393; E06C 7/02

(57) ABSTRACT

Elevator systems and elevator ceiling access systems include a ceiling panel of an elevator car and a platform assembly removably attached to the ceiling panel. The platform assembly includes a platform, a first ladder, and a second ladder. The platform assembly is deployable from a stowed state to a deployed state. In the deployed state, the first ladder and the second ladder support the platform and the platform assembly is detachable from the ceiling panel.

This application claims priority to India patent application No. 202411099940, filed Dec. 17, 2024, and all the benefits accruing therefrom under 35 U.S.C. § 119, the contents of which in its entirety are herein incorporated by reference.

### BACKGROUND

The subject matter disclosed herein generally relates to elevator systems and, more particularly, to elevator access systems and in particular to elevator car ceiling access systems.

Elevator systems require maintenance to be performed on the various components thereof, with some such components located exterior from the interior cab of the elevator car. Such components may be arranged on an exterior structure of the elevator car and/or located within an elevator shaft. To perform maintenance on such components, technicians may be required to gain access to the exterior of the elevator car. In some elevator systems, the elevator cars may be provided with a ceiling access panel or similar opening to allow for a technician to access the top of an elevator car from the inside of the elevator car. The ceiling access panels are manually operable and can be difficult to access depending on the size or dimensions of the elevator car. Accordingly, improved access to and operation of ceiling access panels of elevator cars may be advantageous.

### SUMMARY

According to some embodiments, elevator ceiling access systems are provided. The elevator ceiling access systems include a ceiling panel of an elevator car and a platform assembly removably attached to the ceiling panel. The platform assembly includes a platform, a first ladder, and a second ladder. The platform assembly is deployable from a stowed state to a deployed state. In the deployed state, the first ladder and the second ladder support the platform and the platform assembly is detachable from the ceiling panel.

In addition to one or more of the features described above, or as an alternative, further embodiments of the elevator ceiling access systems may include a ceiling frame, wherein the ceiling panel is pivotably mounted to the ceiling frame.

In addition to one or more of the features described above, or as an alternative, further embodiments of the elevator ceiling access systems may include a locking element configured to releasably secure the ceiling panel to the ceiling frame.

In addition to one or more of the features described above, or as an alternative, further embodiments of the elevator ceiling access systems may include at least one biasing element configured to support and connect the ceiling panel to the ceiling frame.

In addition to one or more of the features described above, or as an alternative, further embodiments of the elevator ceiling access systems may include that the ceiling panel is hingedly or pivotably attached to the ceiling frame by one or more hinge elements.

In addition to one or more of the features described above, or as an alternative, further embodiments of the elevator ceiling access systems may include at least one mounting rail configured as part of or attached to the ceiling panel, wherein the platform assembly is supported on the at least one mounting rail in the stowed state and in the deployed state, and the platform assembly is configured to releasably detach from the at least one mounting rail.

In addition to one or more of the features described above, or as an alternative, further embodiments of the elevator ceiling access systems may include that the platform assembly comprises at least one platform rail that pivotably connects to the at least one mounting rail.

In addition to one or more of the features described above, or as an alternative, further embodiments of the elevator ceiling access systems may include that the at least one platform rail is releasably secured to the mounting rail by at least one locking pin.

In addition to one or more of the features described above, or as an alternative, further embodiments of the elevator ceiling access systems may include that the platform assembly further comprises a safety rail system that is configured to attach to the platform.

In addition to one or more of the features described above, or as an alternative, further embodiments of the elevator ceiling access systems may include that the safety rail system comprises collapsible elements configured to be stored on the platform assembly when the platform assembly is in the stowed state.

In addition to one or more of the features described above, or as an alternative, further embodiments of the elevator ceiling access systems may include that each of the first ladder and the second ladder are hingedly attached to the platform.

In addition to one or more of the features described above, or as an alternative, further embodiments of the elevator ceiling access systems may include that the first ladder is stored on a first side of the platform in the stowed state and the second ladder is stored on a second side of the platform in the stowed state, wherein the first side and second side are opposite sides of the platform.

In addition to one or more of the features described above, or as an alternative, further embodiments of the elevator ceiling access systems may include that the platform assembly is configured to be unfolded from the stowed state to the deployed state from the ceiling panel.

In addition to one or more of the features described above, or as an alternative, further embodiments of the elevator ceiling access systems may include that each of the first ladder and the second ladder are releasably secured to the platform by respective ladder locks.

In addition to one or more of the features described above, or as an alternative, further embodiments of the elevator ceiling access systems may include that the first ladder is secured between the platform and the ceiling panel in the stowed state and the second ladder is releasably secured to the platform by a ladder lock.

In addition to one or more of the features described above, or as an alternative, further embodiments of the elevator ceiling access systems may include that the platform assembly is releasably secured to the ceiling panel by at least one platform lock.

In addition to one or more of the features described above, or as an alternative, further embodiments of the elevator ceiling access systems may include that at least one of the first ladder and the second ladder is a collapsible ladder.

In addition to one or more of the features described above, or as an alternative, further embodiments of the elevator ceiling access systems may include that at least one of the first ladder and the second ladder is a telescoping ladder.

According to some embodiments, elevator systems are provided. The elevator system includes an elevator car having a floor, a ceiling, and side walls defining an interior of the elevator car. A ceiling frame defines an opening in the ceiling of the elevator car. A ceiling panel is arranged to cover the opening and is configured to be opened to expose the opening. A platform assembly is releasably attached to the ceiling panel, and stored in a position outside of the interior of the elevator car in a stowed state. The platform assembly includes a platform, a first ladder, and a second ladder. The platform assembly is deployable from a stowed state to a deployed state. In the deployed state, the first ladder and the second ladder support the platform and the platform assembly is detachable from the ceiling panel.

In addition to one or more of the features described above, or as an alternative, further embodiments of the elevator systems may include that the elevator car is an overslung elevator car.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of a landing door of an elevator system that may employ various embodiments of the present disclosure;

FIG. 3 is a schematic illustration of an elevator car having a ceiling access system and platform assembly in accordance with an embodiment of the present disclosure;

FIG. 4A is a schematic illustration of an elevator ceiling access system in a closed state, in accordance with an embodiment of the present disclosure;

FIG. 4B is a schematic illustration of the elevator ceiling access system of FIG. 4A with a ceiling panel in an open state and a platform assembly mounted to the ceiling panel;

FIG. 4C is a schematic illustration of the elevator ceiling access system of FIG. 4A illustrating the platform assembly in a partially deployed state;

FIG. 4D is a schematic illustration of the elevator ceiling access system of FIG. 4A illustrating the platform assembly in a deployed state;

FIG. 5A is a schematic illustration of a portion of an elevator ceiling access system in accordance with an embodiment of the present disclosure;

FIG. 5B is an enlarged schematic illustration of a portion of the elevator ceiling access system of FIG. 5A;

FIG. 6A is a schematic illustration of a portion of an elevator ceiling access system in accordance with an embodiment of the present disclosure;

FIG. 6B is an enlarged schematic illustration of a portion of the elevator ceiling access system of FIG. 6A;

FIG. 7A is a schematic illustration of an elevator ceiling access system in accordance with an embodiment of the present disclosure;

FIG. 7B is a schematic illustration of a platform assembly of the elevator ceiling access system of FIG. 7A;

FIG. 7C is an enlarged detailed illustration of a portion of the elevator ceiling access system of FIG. 7A;

FIG. 7D is an enlarged detailed illustration of another portion of the elevator ceiling access system of FIG. 7A;

FIG. 8A is a schematic illustration of an elevator ceiling access system in accordance with an embodiment of the present disclosure;

FIG. 8B is a schematic illustration showing a platform assembly of the elevator ceiling access system of FIG. 8A as separated from a ceiling panel of the elevator ceiling access system;

FIG. 9 is a schematic illustration of an elevator ceiling access system in accordance with another embodiment of the present disclosure; and

FIG. 10 is a schematic illustration of an elevator ceiling access system in accordance with another embodiment of the present disclosure.

### DETAILED DESCRIPTION

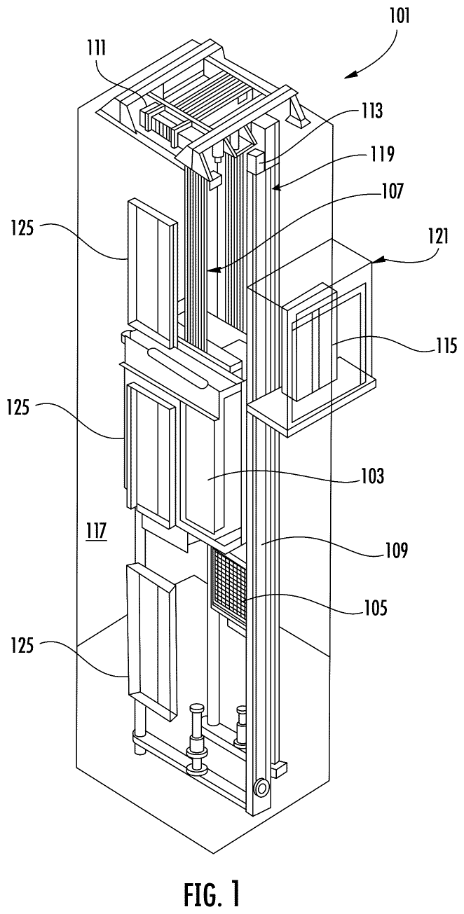

FIG. 1 is a perspective view of an elevator system 101 including an elevator car 103, a counterweight 105, a roping 107, a guide rail 109, a machine 111, a position encoder 113, and an elevator controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which, in this illustrative embodiment, is part of an overhead structure of the elevator system 101, although other arrangements are possible without departing from the scope of the present disclosure. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown in the illustrative arrangement, in a controller room 121 of the elevator shaft 117 and is configured to control the operation of the elevator system 101, and particularly the elevator car 103. In other embodiments the controller 115 can be located in other locations, including, but not limited to, fixed to a landing or landing door or located in a cabinet at a landing. The elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

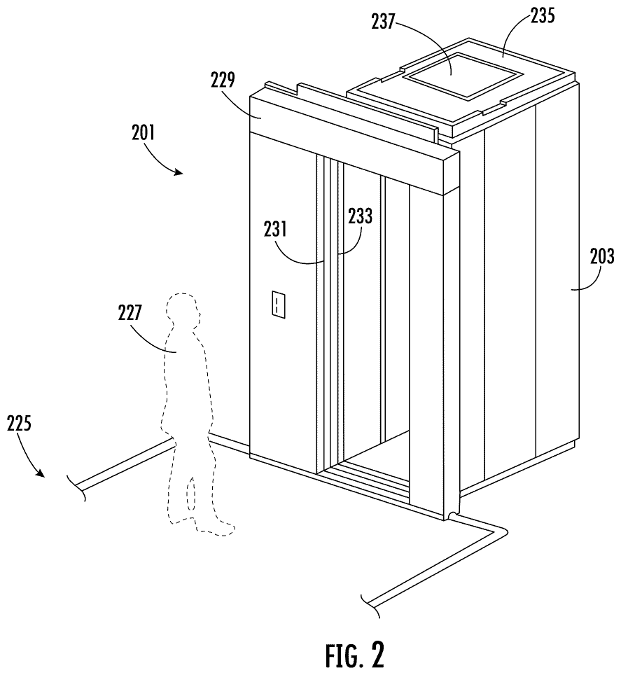

FIG. 2 is a schematic illustration of an elevator system 201 that may incorporate embodiments disclosed herein. As shown in FIG. 2, an elevator car 203 is located at a landing 225. The elevator car 203 may be called to the landing 225 by a user 227 (e.g., passenger or mechanic) that desires to travel to another floor within a building or perform maintenance on a portion of the elevator system 201. A car door lintel 229 of the elevator system 201 can include a door opening system or door operator to enable opening and closing of car doors 231 and landing doors 233 when the elevator car 203 is located at the landing 225. At times, such as during maintenance operations, a mechanic 227 may need to access an elevator car top 235 through a ceiling access panel 237.

In conventional systems, the mechanic 227 may be required to bring a step ladder and/or other equipment into the elevator car 203, in order to perform maintenance through the ceiling access panel 237. This requires additional equipment to be carried by the mechanic. Embodiments provided herein are directed to improved systems for accessing, opening, and operating ceiling access panels and providing access to an elevator car top, such as for inspection and/or maintenance operations. In accordance with embodiments of the present disclosure, elevator ceiling access systems are described having platforms and ladders that are stowed at/on the elevator and improve ease of use, safety, access, and the like among other benefits, as will be appreciated by those of skill in the art.

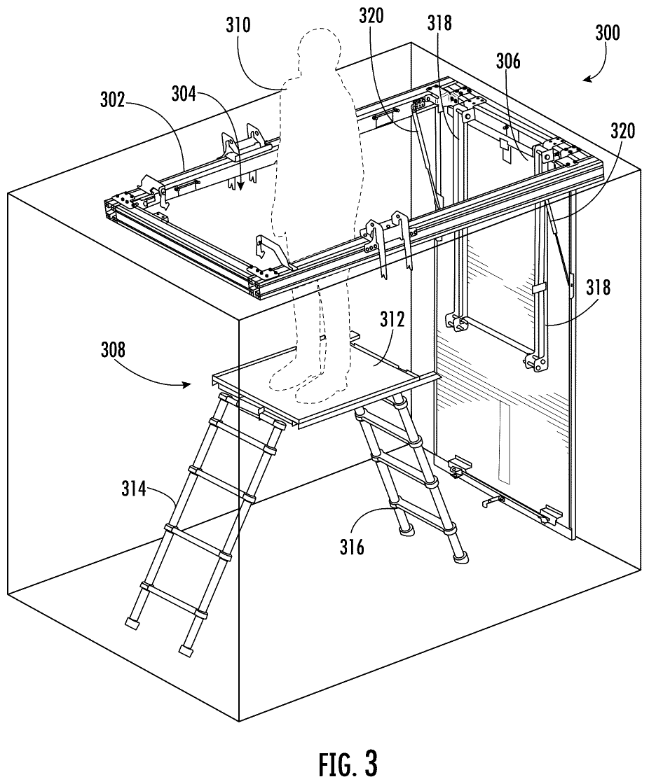

Referring now to FIG. 3, a schematic illustration of an elevator car 300 in accordance with an embodiment of the present disclosure is shown. The elevator car 300 includes a ceiling frame 302 that defines an opening 304 therein. The opening 304 may be selectively opened (e.g., as shown) and closed or sealed by a ceiling panel 306. The ceiling panel 306 is hingedly attached or connected to the ceiling frame 302, and is shown in an open state in FIG. 3. The elevator car 300 includes a platform assembly 308 that may be used by a technician 310 to access the opening 304 in order to perform inspections, maintenance operations, and the like. The platform assembly 308 includes a platform 312, a first ladder 314, and a second ladder 316.

In accordance with embodiments of the present disclosure, the platform assembly 308 is configured to be removably attachable to the ceiling panel 306 such that the platform assembly 308 is stored and housed at/on the elevator car 300, thus eliminating the need for extra ladders or the like to be brought onsite and into the elevator car 300 when ceiling access is required. The ladders 314, 316 may be hingedly or pivotably attached to the platform 312 or may be removably attached thereto, depending on the specific implementation thereof. The platform 312 is configured to removably attach to the ceiling panel 306, such as on one or more mounting rails 318. The ceiling panel 306 is supported on the ceiling frame 302 at one end or side of the ceiling panel 306 and by one or more biasing elements 320 (e.g., gas springs, pistons, telescoping supports, etc.).

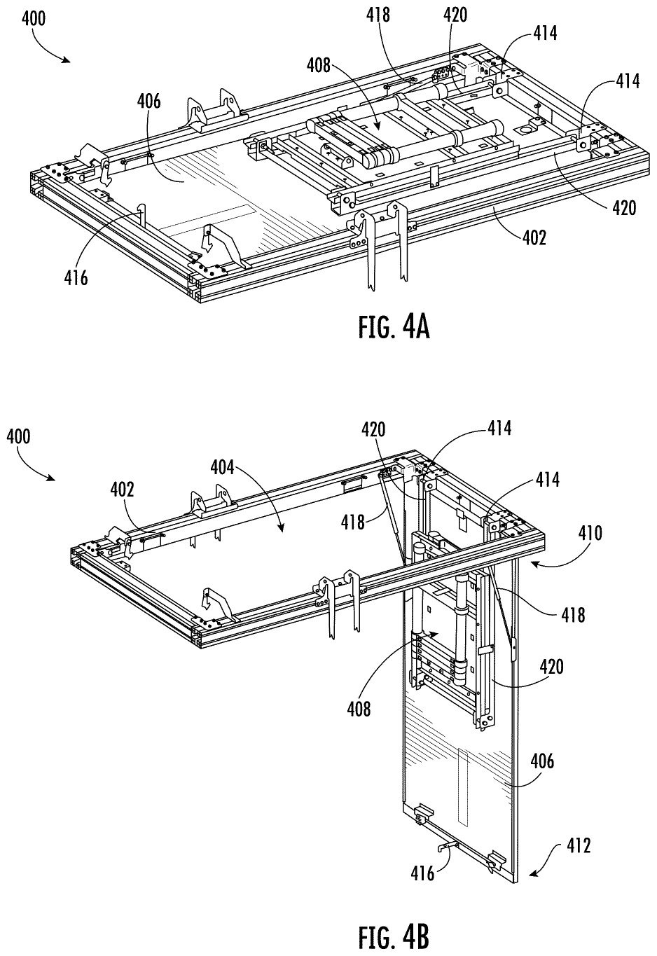

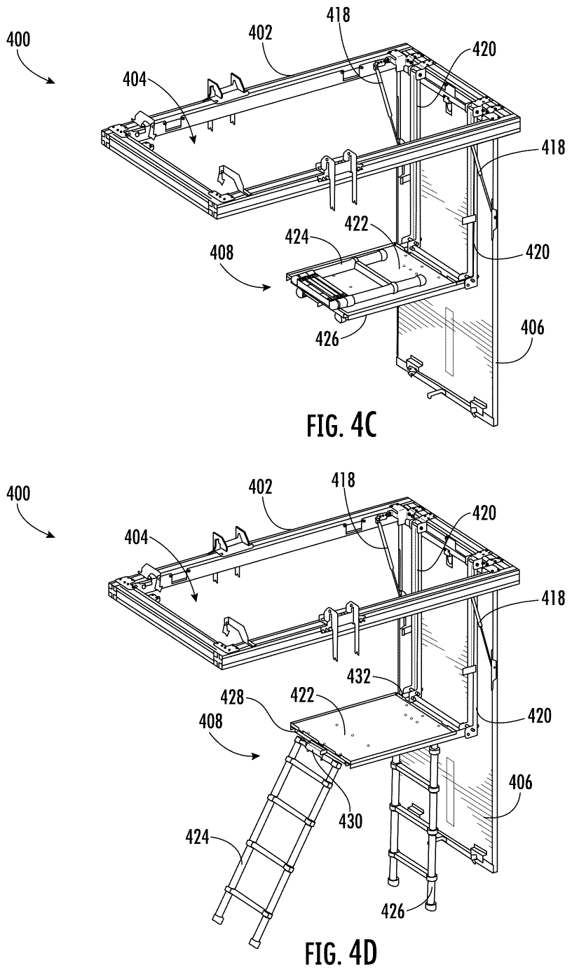

Referring now to FIGS. 4A-4D, schematic illustrations of operation of an elevator ceiling access system 400 for an elevator system in accordance with an embodiment of the present disclosure are shown. The elevator ceiling access system 400 may be installed on or may be part of an elevator car, for example as shown in FIG. 3. The elevator ceiling access system 400 includes a ceiling frame 402 that defines an opening 404 which is selectively covered or closed by a ceiling panel 406. Removably attached or mounted to the ceiling panel 406 is a platform assembly 408. FIG. 4A illustrates the ceiling panel 406 and platform assembly 408 in a closed or stowed state and FIG. 4B illustrates the ceiling panel 406 and platform assembly 408 in an open state, with the platform assembly 408 still stowed or secured on the ceiling panel 406. FIGS. 4C-4D illustrate steps of deploying the platform assembly 408, and an illustration of a fully deployed platform assembly is shown and illustrated in FIG. 3, above.

Referring to FIG. 4A, in the stowed state, the ceiling panel 406 is closed and secured into a locked position relative to the ceiling frame 402. The locking of the ceiling panel 406 to the ceiling frame 402 may be known conventional means, such as fasteners, detent pins, locking elements (e.g., triangular key), or the like, as will be appreciated by those of skill in the art. The ceiling panel 406 has a first end 410 and a second end 412. The first end 410 of the ceiling panel 406 is hingedly or pivotably attached to the ceiling frame 402 by one or more hinge elements 414. The second end 412 of the ceiling panel 406 is configured to selectively attach to a portion of the ceiling frame 402 and is releasable therefrom to allow for opening of the ceiling panel 406 and exposing the opening 404. For example, the second end 412 of the ceiling panel 406 may include a locking element 416, which may be actuated to unlock and release the attachment between the ceiling panel 406 and the ceiling frame 402. With the opening 404, a user (e.g., mechanic) can access a top of the elevator car and gain access to the exterior of the elevator car through the top (e.g., elements within an elevator shaft or on top of the elevator car).

The ceiling panel 406 may be supported by one or more biasing elements 418, such as pistons, springs, or the like. The biasing elements 418 may be provided to aid in opening and closing the ceiling panel 406, such as to ease the lowering of the ceiling panel 406 from the closed state (FIG. 4A) to the open state (FIG. 4B), and/or for aiding closing of the ceiling panel from the open state to the closed state.

The platform assembly 408 is removably attached to the ceiling panel 406 on one or more mounting rails 420. The mounting rails 420 may be configured to provide support and hinged rotation of the ceiling panel 406 relative to the ceiling frame 402 while also supporting the platform assembly 408 thereon. The mounting rails 420 may be fixedly attached to the ceiling panel 406, such as by fasteners, welding, or the like. In other embodiments, the mounting rails 420 may be integrally formed with the ceiling panel 406. The platform assembly 408 may be removably attached to the ceiling panel 406 by one or more securing elements, as described herein.

As shown in FIGS. 4A-4B, the ceiling panel 406 may be opened to expose the opening 404. In the open state of the ceiling panel 406, the platform assembly 408 is exposed and available to be accessed and used. FIGS. 4C-4D illustrate additional steps for deploying, accessing, and using the platform assembly 408. The platform assembly 408 includes a platform 422, a first ladder 424, and a second ladder 426. When stowed, the first ladder 424 and the second ladder 426 are secured to the platform 422, which is secured as a complete assembly to the ceiling panel 406. As shown in FIG. 4C, the platform assembly 408 may be folded downward from the ceiling panel 406. In this orientation, the platform assembly 408 is attached to and supported by the mounting rails 420 on one side of the platform 422. That is, the platform 422 is hingedly mounted to the ceiling panel 406 at one end or side thereof. When the platform assembly 408 is folded down from the stowed position (FIG. 4B) to the partially deployed position (FIG. 4C), the platform assembly 408 is supported by the connection between the platform 422 and the mounting rails 420.

Once deployed in the partially deployed position (FIG. 4C), a user may then deploy the ladders 424, 426. The user will unlock or disconnect the ladders 424, 426 from being secured to the platform 422. The ladders 424, 426 may then be unfolded or otherwise deployed, as shown in FIG. 4D. The first ladder 424 may be configured to secure to a top side of the platform 422 and may be hingedly or pivotably attached to a first end 428 of the platform 422 by a first ladder connection 430. The second ladder 426 may be configured to secure to a bottom side of the platform 422 and may be hingedly or pivotably attached to a second end 432 of the platform 422 by a second ladder connection (not shown). The ladders 424, 426 may be configured to provide stability and support to the platform 422 while also providing a means for climbing from a floor of an elevator car onto the platform 422. The ladders 424, 426 may be adjustable in length/height. For example, the ladders 424, 426 may be collapsible ladders, such as telescoping or folding or separable/attachable segments, that can be stowed in a collapsed state and deployed to various lengths/heights for use.

The platform 422 may be releasable from the ceiling panel 406. By disconnecting the platform 422 from the ceiling panel 406, the platform assembly 408 may be moved around within an elevator car (or moved outside an elevator car) to position the platform at a desired or appropriate location for performing an intended task or accessing specific components in various locations. For example, as shown in FIG. 3, and further described below, the platform assembly 408 may be detached from the ceiling panel 406, and the ladders 424, 426 may be used to support the platform 422 and provide steps for access to stand on the platform 422.

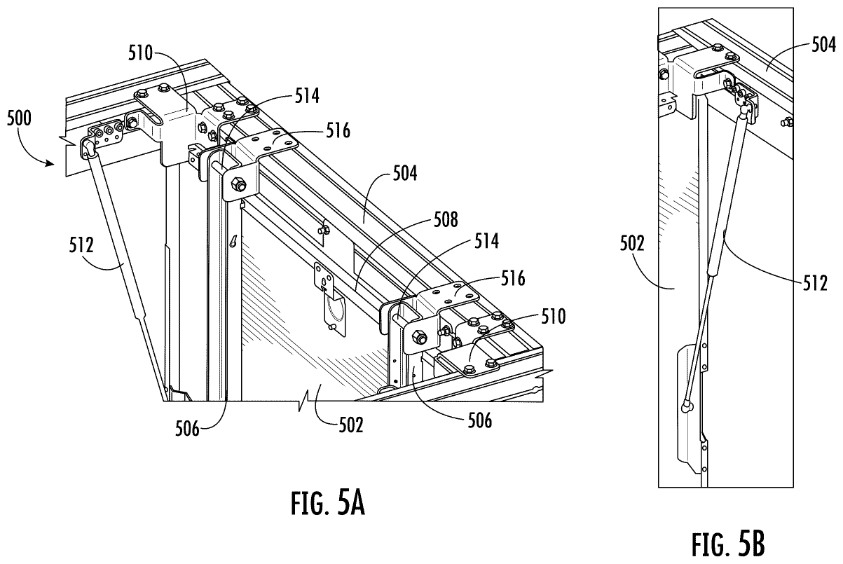

Referring now to FIGS. 5A-5B, schematic illustrations of a portion of an elevator ceiling access system 500 in accordance with an embodiment of the present disclosure are shown. The elevator ceiling access system 500 may be similar to that shown and described above. FIG. 5A illustrates a connection between a ceiling panel 502 and a ceiling frame 504. The ceiling panel 502 includes one or more mounting rails 506. The mounting rails 506 are fixedly attached to the ceiling panel 502 by fasteners or other connection or attachment mechanisms. The ceiling panel 502 may be additionally supported on the ceiling frame 504 by a secondary support element 508 that is rotationally supported by one or more support brackets 510. Additionally, support and connection between the ceiling panel 502 and the ceiling frame 504 may be provided by one or more biasing elements 512, as described above. The mounting rails 506 are pivotably or hingedly connected to the ceiling frame 504 by respective pivot pins 514, which are supported on respective support brackets 516 that are fixedly attached to the ceiling frame 504. FIG. 5B illustrates enlarged detail of the biasing elements 512 and the connection between the ceiling panel 502 and the ceiling frame 504.

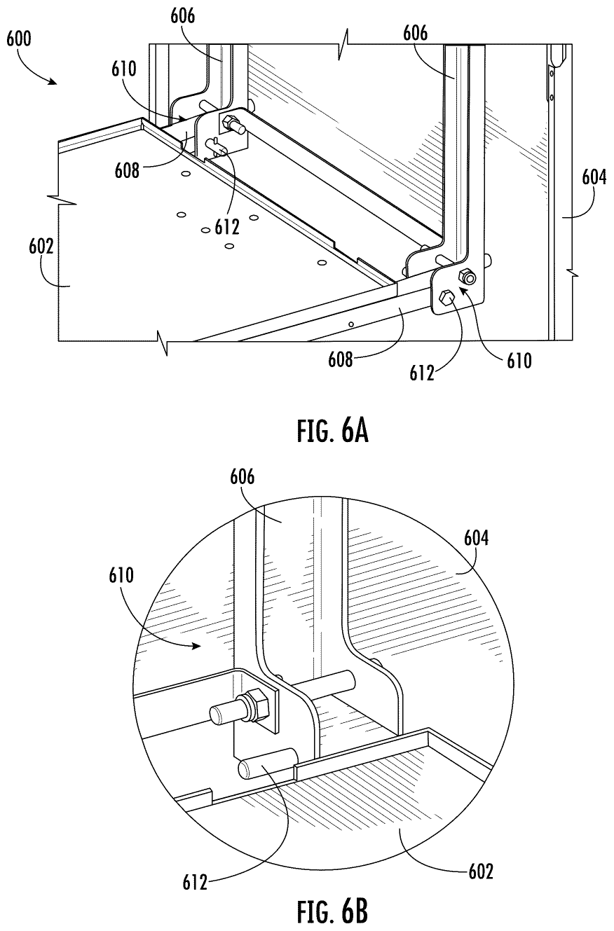

Referring now to FIGS. 6A-6B, schematic illustrations of a portion of an elevator ceiling access system 600 in accordance with an embodiment of the present disclosure are shown. The elevator ceiling access system 600 may be similar to that shown and described above. FIG. 6A illustrates a connection between a platform 602 and a ceiling panel 604. The platform 602 is configured to be part of a platform assembly and may support or carry one or more ladders (not shown in FIGS. 6A-6B for clarity) as shown and described herein. The platform 602 is releasably attached to the ceiling panel 604 along one or more mounting rails 606. As shown, the platform 602 may be supported on respective platform rails 608 which hingedly and releasably attach or connect to the mounting rails 606 at respective platform connections 610. The platform connections 610 provide a releasably fixed connection between the platform 602 (e.g., platform rails 608) and the ceiling panel 604 (e.g., mounting rails 606). The platform connections 610 are configured as rotating or pivoting connections to allow for the platform 602 to fold down or pivot relative to the ceiling panel 604. The platform 602 may be released from connection with the ceiling panel 604 by means of locking pins 612 (e.g., cotter pins, threaded fasteners, detent pins, etc.). FIG. 6B illustrates enlarged details of one of the platform connections 610.

During use, a user may release the ceiling panel 604 from engagement with a ceiling frame, such as shown and described above. With the ceiling panel 604 folded downward, the platform 602 may be released from engagement with the ceiling panel 604 and folded downward into the orientation shown in FIGS. 6A-6B. A user may then deploy one or more ladders (not shown) from the platform 602 and/or may disconnect the platform 602 from the ceiling panel 604 by unlocking the locking pins 612. By unlocking the locking pins 612, in this illustrative configuration, the platform rails 608 may be disconnected or separated from the mounting rails 606, allowing for the user to move the platform 602 freely and separately from the ceiling panel 604. When use is complete, the user may reattach or reconnect the platform rails 608 to the mounting rails 606 using the locking pins 612, thereby attaching the platform 602 to the ceiling panel 604. The platform 602 may then be rotated upward about the pivots or hinges of the platform connections 610 to stow or store the platform 602 (and other parts of the platform assembly).

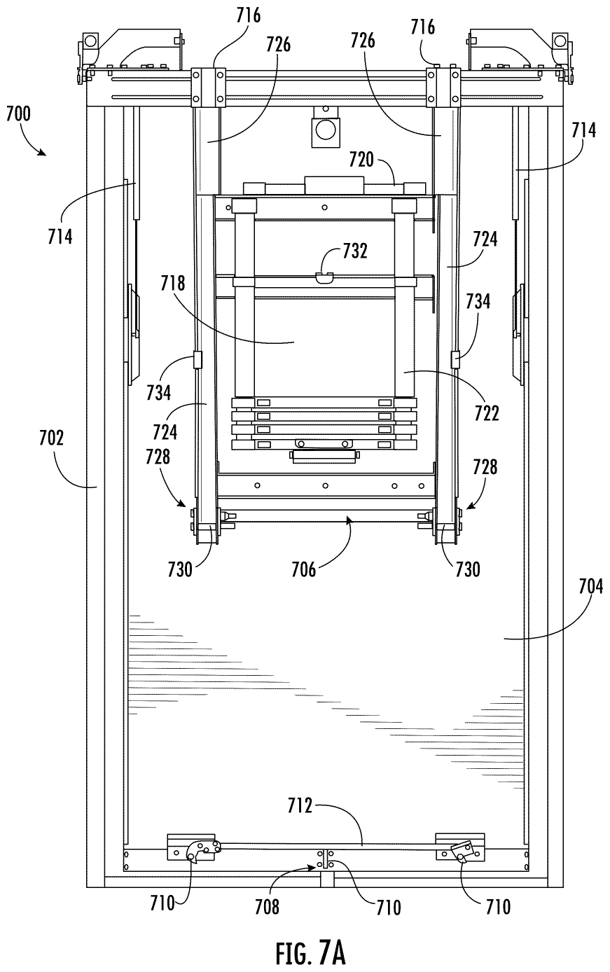

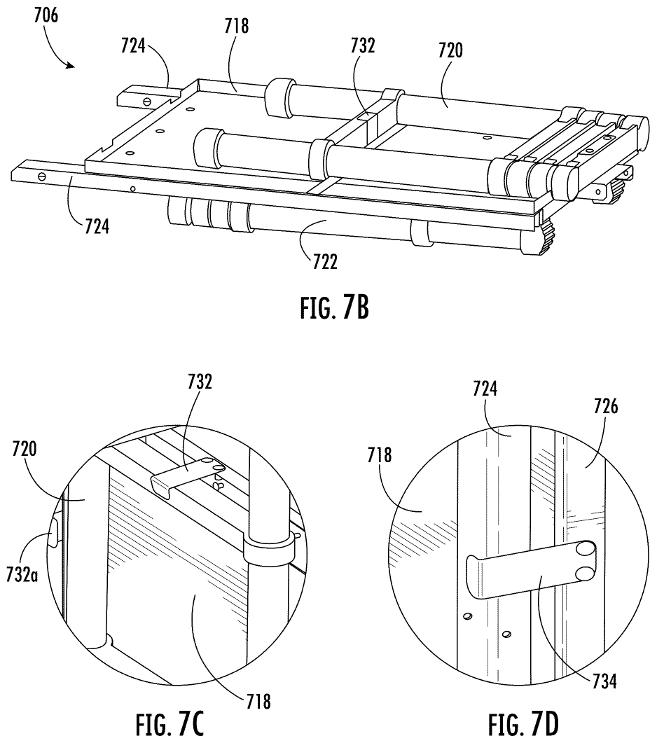

Referring now to FIGS. 7A-7D, schematic illustrations of an elevator ceiling access system 700 and features thereof in accordance with an embodiment of the present disclosure are shown. FIG. 7A illustrates a top down view of the elevator ceiling access system 700, including a portion of a ceiling frame 702, a ceiling panel 704, and a platform assembly 706. The platform assembly 706 is shown in a stored or stowed position in FIG. 7A, with the ceiling panel 704 closed and secured to the ceiling frame 702. The ceiling panel 704 may be secured in the closed state by a number of different mechanisms or features. For example, at one end of the ceiling panel 704 a locking element 708 is provided that may include one or more locks 710 that are joined by a locking connector 712. The locking connector 712 may be configured to enable simultaneous operation of two or more of the locks 710 to release the connection between the ceiling panel 704 and the ceiling frame 702. At the opposite end of the ceiling panel 704, the ceiling panel 704 may be attached or connected to the ceiling frame 702 by one or more biasing elements 714 and/or one or more support brackets 716 and/or a secondary support element (e.g., as shown in FIG. 5A). A first end of the ceiling panel 704 is pivotably or rotationally connected to the ceiling frame 702 by the biasing elements 714, the support brackets 716, and/or the secondary support elements. A second end of the ceiling panel 704 is releasably connected to the ceiling frame 702 by the locking element 708.

As shown in FIG. 7A, the platform assembly 706 includes a platform 718, a first ladder 720, and a second ladder 722. In the stowed or stored position, shown in FIG. 7A, and in accordance with this illustrative embodiment, the first ladder 720 is arranged between the platform 718 and the ceiling panel 704 and the second ladder 722 is arranged opposite the first ladder 720 and arranged on the opposite side of the platform 718. Each of the ladders 720, 722 is stored in a collapsed state to minimize the space occupied by the platform assembly 706 and to prevent elements from interfering with each other during use and/or deployment/stowing. The platform assembly 706 is attached to the ceiling panel 704 by a set of platform rails 724 that pivotably connect to mounting rails 726 that are attached to the ceiling panel 704 by respective platform connections 728.

The platform assembly 706 is releasably attached to the mounting rails 726 by one or more locking pins 730. The locking pins 730 may be removed or actuated to enable separation of the platform rails 724 from the mounting rails 726. When stored, such as shown in FIG. 7A, the ladders 720, 722 are secured to the platform 718, and the platform 718 is secured to the mounting rails 726. For example, in this illustrative configuration the ladders 720, 722 are releasably secured to the platform 718 by respective ladder locks 732. Only the ladder lock 732 that secures the second ladder 722 to the platform 718 is shown, with the ladder lock 732 that secures the first ladder 720 to the platform 718 not illustrated as not visible in the view shown, but is substantially similar to that shown for the second ladder 722. The platform 718 is secured in place to the mounting rails 726 by respective platform locks 734. The locks 732, 734 may be tabs, rotating tabs, detent locks, detent pins, snap connections, threaded connections, fasteners, magnetic connections, or the like, that are able to be manipulated, operated, or actuated to allow selective release of the platform 718 from the mounting rails 726 and selective release of the respective ladders 720, 722.

FIG. 7B illustrates the platform assembly 706 as separated from the ceiling panel 704. FIG. 7B illustrates the opposite side of the platform assembly 706 than that shown in FIG. 7A, with the ladder lock 732 securing the first ladder 720 to the platform 718, and the second ladder 722 is similarly secured. In other configurations, the first ladder 720 may be held in place merely by being positioned between and held in place by surfaces of the platform 718 and the ceiling panel 704. Accordingly, in some embodiments, only the second ladder 722 (e.g., exterior ladder) may require a ladder lock 732. FIG. 7C illustrates an enlarged view of the ladder lock 732 that secures the ladder 720 to the platform 718. As shown in FIG. 7C, one or more secondary ladder locks 732a may be provided to secure other parts of the ladder 720 to the platform 718 and/or the ceiling panel 704. Such secondary ladder locks 732a may be used to help position and retain the ladder(s) 720, 722 or other components and may be configured to prevent unintentional falling or deployment of the ladder 720, 722 during movement of the platform 718. FIG. 7D illustrates an enlarged view of the platform lock 734 that releasably connects the platform rail 724 to the mounting rail 726.

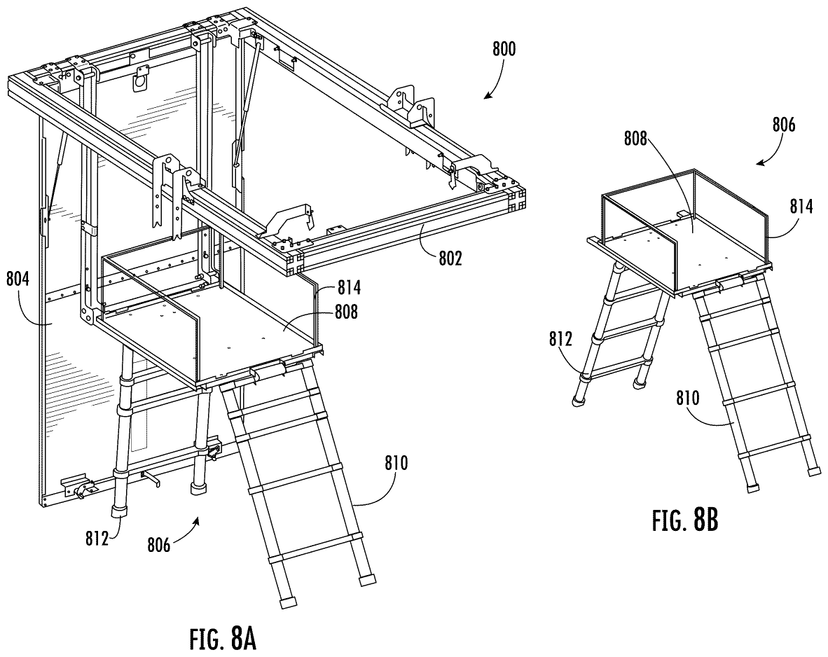

Referring now to FIGS. 8A-8B, schematic illustrations of an elevator ceiling access system 800 in accordance with an embodiment of the present disclosure are shown. The elevator ceiling access system 800 may be similar to that shown and described above, and thus like features may not be described again. As shown in FIG. 8A, the elevator ceiling access system 800 includes a ceiling frame 802 that is part of an elevator car. A ceiling panel 804 is configured to open and close relative to the ceiling frame 802 and is pivotably or rotationally mounted to the ceiling frame 802. A platform assembly 806 is provided on the ceiling panel 804 and is removably attached thereto. The platform assembly 806, as shown in FIGS. 8A-8B, includes a platform 808, a first ladder 810, and a second ladder 812. In this illustrative embodiment, the platform assembly 806 includes a safety rail system 814. The safety rail system 814 may be a set of collapsible or removably attachable rails that can be arranged about a perimeter of the platform 808. The safety rail system 814 may be used to provide safety to a user of the platform assembly 806. The safety rail system 814 may be configured to be fixedly attached to the platform 808 and provide a stop or edge rail to prevent a user from falling off the platform 808 or making a misstep or the like. In some embodiments, the rails of the safety rail system 814 may be telescoping poles, in other configurations, the poles/rails of the safety rail system 814 may be collapsible or foldable to be stowed on/to the platform 808, similar to the stowing of the ladders 810, 812 to the platform 808. As shown in FIG. 8B, the platform assembly 806 can be used in isolation or separate from the ceiling panel 804. That is, the platform assembly 806 may be selectively removed or detached from the ceiling panel 804, and the platform assembly 806 may be moved around to a desired location within an elevator car (or elsewhere).

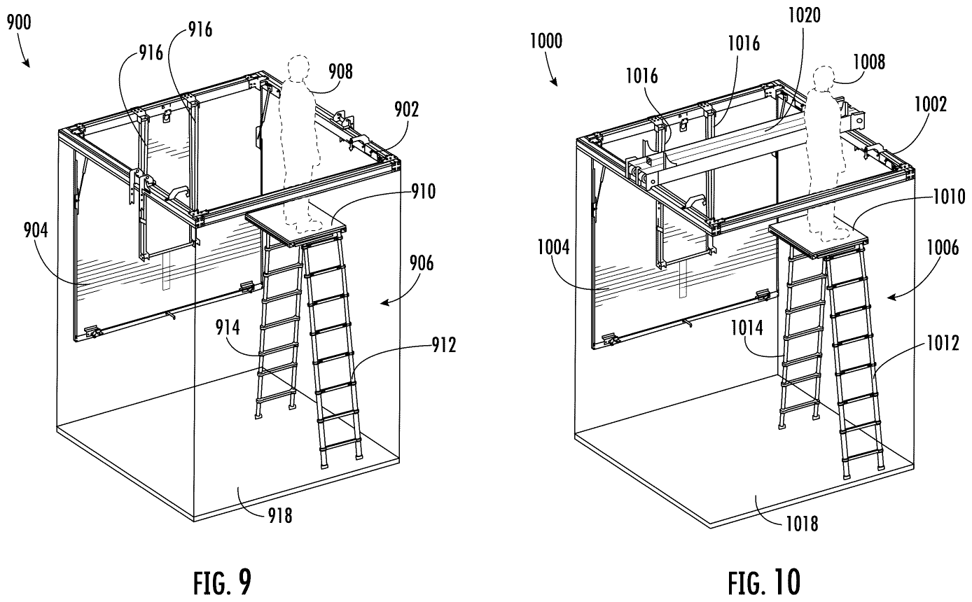

Referring now to FIG. 9, a schematic illustration of an elevator car 900 in accordance with an embodiment of the present disclosure is shown. The elevator car 900 includes a ceiling frame 902 that defines an opening therein. The opening may be selectively opened (e.g., as shown) and closed or sealed by a ceiling panel 904. The ceiling panel 904 is hingedly attached or connected to the ceiling frame 902, and is shown in an open state in FIG. 9. The elevator car 900 includes a platform assembly 906 that may be used by a technician 908 to access the opening in order to perform inspections, maintenance operations, and the like. The platform assembly 906 includes a platform 910, a first ladder 912, and a second ladder 914. In the illustration of FIG. 9, the platform assembly 906 has been removed from attachment to the ceiling panel 904, and from mounting rails 916 that are attached to or part of the ceiling panel 904. As shown, the platform assembly 906 is moved away from the ceiling panel 904 to a specific (e.g., edge) location on a floor 918 of the elevator car 900. It will be appreciated that the opening defined by the ceiling frame 902 is relatively larger than the illustrative configurations shown above. Because the platform assembly 906 can be detached and moved around by the mechanic 908, the elevator ceiling access systems described herein may be used in any size/dimension of elevator car while allowing for the mechanic 908 to access any of the sides of the opening defined by the ceiling frame 902.

Referring now to FIG. 10, a schematic illustration of an elevator car 1000 in accordance with an embodiment of the present disclosure is shown. The elevator car 1000 includes a ceiling frame 1002 that defines an opening therein. The opening may be selectively opened (e.g., as shown) and closed or sealed by a ceiling panel 1004. The ceiling panel 1004 is hingedly attached or connected to the ceiling frame 1002, and is shown in an open state in FIG. 10. The elevator car 1000 includes a platform assembly 1006 that may be used by a technician 1008 to access the opening in order to perform inspections, maintenance operations, and the like. The platform assembly 1006 includes a platform 1010, a first ladder 1012, and a second ladder 1014. In the illustration of FIG. 10, the platform assembly 1006 has been removed from attachment to the ceiling panel 1004, and from mounting rails 1016 that are attached to or part of the ceiling panel 1004. As shown, the platform assembly 1006 is moved away from the ceiling panel 1004 to a specific (e.g., edge) location on a floor 1018 of the elevator car 1000. Similar to the configuration of FIG. 9, the opening defined by the ceiling frame 1002 in FIG. 10 is relatively larger than the illustrative configurations shown above. In this configuration, the elevator car 1000 is an overslung configuration having a structural frame element 1020 spanning the opening defined by the ceiling frame 1002. Even with such blockage of the opening by the structural frame element 1020, because the platform assembly 1006 can be detached and moved around by the mechanic 1008 access to any of the sides of the opening defined by the ceiling frame 1002 and/or around the structural frame element 1020 may be achieved.

Advantageously, embodiments of the present disclosure are directed to elevator ceiling access systems that provide benefits over current solutions. For example, in accordance with some embodiments, the need for a mechanic to bring a ladder to an elevator is eliminated, as the ladder and platform systems of the present disclosure may be stored on/at the elevator car to be serviced. Further, advantageously, embodiments of the present disclosure can reduce or eliminate wear or damage that may be caused to the elevator car due to additional tools and equipment being brought to the elevator car. Furthermore, the platform assemblies described herein may be used by any user/mechanic, because the platform system is provided at the elevator car, and may be sized to accommodate access to the ceiling, the top of the car, or the like. Additionally, embodiments of the present disclosure do not require any special or specific tools or equipment to operate. For example, opening and closing of the ceiling panel may be assisted by biasing elements (e.g., pistons, springs, etc.). Furthermore, advantageously, the elevator ceiling access systems described herein may be used in both overslung and underslung roping elevator configurations.

In accordance with embodiments of the present disclosure, a single solution for use with multiple different elevator configurations (e.g., size, shape, dimensions) is provided. That is, the same or essentially the same access system and platform assembly may be used for a variety of different elevator configurations (e.g., for example as shown in FIGS. 3, 9, 10). The disclosed systems may be installed on a ceiling panel of an elevator car to provide access to the ceiling or areas outside and above the elevator car. The platform assemblies may be manufactured or assembled separately from and then installed to the ceiling panels. As such, in accordance with some embodiments, the disclosed platform assemblies do not require a specific ceiling panel configuration to be employed. As a result, manufacturing the platform assemblies can be standardized and installation processes may be the same for all or most elevator configurations, resulting in lower costs associated with manufacture and/or installation, while also providing improved safety to mechanics and the like once installed and in use.

As used herein, the use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator ceiling access system comprising:
a ceiling panel of an elevator car; and
a platform assembly removably attached to the ceiling panel, the platform assembly comprising a platform, a first ladder, and a second ladder,
wherein the platform assembly is deployable from a stowed state to a deployed state, wherein in the deployed state, the first ladder and the second ladder support the platform and the platform assembly is detachable from the ceiling panel.

2. The elevator ceiling access system of claim 1, further comprising a ceiling frame, wherein the ceiling panel is pivotably mounted to the ceiling frame.

3. The elevator ceiling access system of claim 2, further comprising a locking element configured to releasably secure the ceiling panel to the ceiling frame.

4. The elevator ceiling access system of claim 2, further comprising at least one biasing element configured to support and connect the ceiling panel to the ceiling frame.

5. The elevator ceiling access system of claim 2, wherein the ceiling panel is hingedly or pivotably attached to the ceiling frame by one or more hinge elements.

6. The elevator ceiling access system of claim 1, further comprising at least one mounting rail configured as part of or attached to the ceiling panel, wherein the platform assembly is supported on the at least one mounting rail in the stowed state and in the deployed state, and the platform assembly is configured to releasably detach from the at least one mounting rail.

7. The elevator ceiling access system of claim 6, wherein the platform assembly comprises at least one platform rail that pivotably connects to the at least one mounting rail.

8. The elevator ceiling access system of claim 7, wherein the at least one platform rail is releasably secured to the mounting rail by at least one locking pin.

9. The elevator ceiling access system of claim 1, wherein the platform assembly further comprises a safety rail system that is configured to attach to the platform.

10. The elevator ceiling access system of claim 9, wherein the safety rail system comprises collapsible elements configured to be stored on the platform assembly when the platform assembly is in the stowed state.

11. The elevator ceiling access system of claim 1, wherein each of the first ladder and the second ladder are hingedly attached to the platform.

12. The elevator ceiling access system of claim 1, wherein the first ladder is stored on a first side of the platform in the stowed state and the second ladder is stored on a second side of the platform in the stowed state, wherein the first side and second side are opposite sides of the platform.

13. The elevator ceiling access system of claim 1, wherein the platform assembly is configured to be unfolded from the stowed state to the deployed state from the ceiling panel.

14. The elevator ceiling access system of claim 1, wherein each of the first ladder and the second ladder are releasably secured to the platform by respective ladder locks.

15. The elevator ceiling access system of claim 1, wherein the first ladder is secured between the platform and the ceiling panel in the stowed state and the second ladder is releasably secured to the platform by a ladder lock.

16. The elevator ceiling access system of claim 1, wherein the platform assembly is releasably secured to the ceiling panel by at least one platform lock.

17. The elevator ceiling access system of claim 1, wherein at least one of the first ladder and the second ladder is a collapsible ladder.

18. The elevator ceiling access system of claim 1, wherein at least one of the first ladder and the second ladder is a telescoping ladder.

19. An elevator system comprising:
an elevator car having a floor, a ceiling, and side walls defining an interior of the elevator car;
a ceiling frame defining an opening in the ceiling of the elevator car;
a ceiling panel arranged to cover the opening and configured to be opened to expose the opening; and
a platform assembly releasably attached to the ceiling panel, and stored in a position outside of the interior of the elevator car in a stowed state, the platform assembly comprising a platform, a first ladder, and a second ladder, and wherein the platform assembly is deployable from a stowed state to a deployed state, wherein in the deployed state, the first ladder and the second ladder support the platform and the platform assembly is detachable from the ceiling panel.

20. The elevator system of claim 19, wherein the elevator car is an overslung elevator car.
